(19) United States
(12) Patent Application Publication
(10) Pub. No.: US 2020/0193057 A1
(43) Pub. Date: Jun. 18, 2020

(54) PRIVACY ENHANCED DATA LAKE FOR A TOTAL CUSTOMER VIEW

(71) Applicant: AMARIS.AI PTE. LTD., Singapore (SG)

(72) Inventors: Chien Siang YU, Singapore (SG); Khue Hiang CHAN, Singapore (SG)

(21) Appl. No.: 16/713,016

(22) Filed: Dec. 13, 2019

Related U.S. Application Data
(60) Provisional application No. 62/778,896, filed on Dec. 13, 2018.

(51) Int. Cl. G06F 21/62; G06F 16/31; G06N 20/00; G06N 3/00; G06Q 20/40

(52) U.S. Cl. CPC G06F 21/6245; G06F 16/31; G06F 40/205; G06N 3/006; G06Q 20/401; G06N 20/00

(57) ABSTRACT

An AI enhanced privacy data lake is disclosed. A processing module processes instream transactions to identify privacy data, such as personally identifiable information (PII), and encrypts it using tokenization with format preserving encryption (FPE). The processed instream transactions are stored in the data lake as data fragments with tagging to enable easy consolidation to provide a complete 360° view of customers while complying with privacy data regulations.

### CROSS-REFERENCE TO RELATED APPLICATION

This application claims the benefit of U.S. Provisional Application No. 62/778,896, filed on Dec. 13, 2018, which is incorporated herein by reference in its entirety for all purposes.

### FIELD OF THE INVENTION

The present disclosure relates to data storage systems. In particular, the present disclosure relates to data lakes with enhanced data privacy protection while providing a total 360° customer view.

### BACKGROUND

Due to compliance with data regulations, such as GDPR (General Data Protection Regulation), many companies are faced with data protection challenges. Compliance with data regulations requires tracing and controlling the data, irrespective if it is outside or inside the companies data storage system. This has to be granular in security controls for the entire data lifecycle, including data erasure, which is a key requirement in, for example, GDPR. As such, compliance poses a heavy burden on companies.

Furthermore, another problem faced by companies is that data repository systems are silo based. That is, data are under the control of respective departments or groups within a company. Different groups may have different priorities. Silo based data storage configurations make it difficult to comprehend the motivations, thinking and objectives of their customers. This creates difficulties in planning their customers and to predict what the customer would need in order to sell predictively and to build a long term, trusted relationship with customers. The difficulties are exacerbated by customers having different online identities as well as procurements through different channels or agents or purchases which are shared by friends and family members, which is typical in a shared economy. The sheer complexities of today's multi-channel sales and their marketing mechanisms make it difficult to collate and map transactions since they are typically captured in separate and distinct databases. Despite data warehouses, there could be data errors and diverse variable formats that will defy traditional collation, making it virtually impossible to get a 360° view of the customer and his family.

From the foregoing discussion, there is a desire to provide an improved data storage system which is compliant with data regulations and provides a total 360° customer view.

### SUMMARY

Embodiments generally relate to data storage systems, such as data lakes which are compliant with data regulations and provides a total customer view. In one embodiment, a data storage and retrieval system includes a data storage module which includes a data lake for storing unstructured data fragments, a gateway module configured to process instream transactions which includes identifying any privacy data elements in the instream transaction, encrypting the privacy data element or elements, and storing the instream transaction as data fragments in the data storage module. The processing of the instream transactions renders the data storage module compliant with privacy data regulations.

In another embodiment, a method for storing data includes receiving instream transactions from different data sources and processing the instream transactions which includes identifying any data element of a transaction which is privacy sensitive and encrypting the identified privacy sensitive data elements. The method further includes storing the instream transactions into a data lake as unstructured data fragments, including the privacy sensitive data elements, and the data lake contains unstructured data fragments which comply with privacy data regulations and provide a 360° view of customers.

These and other advantages and features of the embodiments herein disclosed, will become apparent through reference to the following description and the accompanying drawings. Furthermore, it is to be understood that the features of the various embodiments described herein are not mutually exclusive and can exist in various combinations and permutations.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of various embodiments. In the following description, various embodiments of the present disclosure are described with reference to the following, in which:

FIG. 1 shows an overview of an embodiment of a system architecture of a data storage and retrieval system;

FIG. 2 shows an embodiment of a component architecture of the system;

FIG. 3 shows an embodiment of processing instream data;

FIG. 4 illustrates an embodiment of tokenization;

FIG. 5 shows an overview of an embodiment of processing of instream transactions;

FIG. 6 shows an overview of an embodiment for processing of requests for data from the system; and

FIG. 7 shows an overview of an embodiment of continuous monitoring of the system for a secure 360° view.

### DETAILED DESCRIPTION

Embodiments described herein generally relate to data storage systems. In particular, the systems are configured for managing Big Data securely and efficiently via a new Privacy by Design architecture. In one embodiment, artificial intelligence (AI) empowered operational systems for specialized data lakes are employed to manage Big Data securely and efficiently. The systems utilize AI semantics parsing via Natural Language Processing (NLP) to understand which part of the incoming data needs to be privacy protected. Such data, for example, includes personally identifiable information (PII). PII data is tokenized or encrypted to comply with confidentiality and privacy exposure issues when stored within a data lake.

In addition, data lakes advantageously allow standard unstructured database systems to be used. The AI systems are configured to create additional data tagging for data fragments or objects, which will result in faster retrieval and higher security granularity when accessed subsequently. As a result, the systems serve as AI input gateways that will sanitize all incoming data elements despite its free text format, acting as a transforming system to transform and render sensitive data unknown to retrieval systems that may be outside of its security perimeter.

In one embodiment, user applications stream different sources of data into a privacy protected data lake. This is in contrast to conventional silo-based data storage systems which stream data into disparate database systems. For example, different types of data, such as Internet of Things (IoT) remote sensing data, transaction data for delivery and payment, as well as other types of data, would be streamed into the data lake in a simple and straight forward manner, thus reducing the otherwise complex development and high cost of handling high velocity and huge volumes of data. A data lake deployment is advantageous when there are many data collectors, allowing each to work autonomously without needing to synchronize with each other. Since the collected data fragments are “dumped” into a mass common store, without field processing, the challenge of exploiting its data analytics and sense making is performed later, such as during data retrieval.

The system, for example, serves as an AI gateway which automatically protects the incoming data, using AI-empowered process automation. The system is inherently self-organizing. For example, the system automatically consolidates all transactions and data for each unique customer, making tracking and updating seamless. Therefore, gaps from incomplete customer data, causing poor marketing decisions would be eliminated. This facilitates seamless 360° customer views. The system further is optimized to support scalable AI recommendations, trends discovery and customer profiling.

The system is based on advanced artificial intelligence for IT operations (AIOps) that is highly secure and locked down, with anti-exfiltration and regulated workflows and strong storage zoning. Additionally, customer data will be fenced off using data diodes. In the case of a cloud-based storage system, software data diodes are used for zoning implementation.

In one embodiment, to strictly limit all privacy-sensitive accesses, users are not allowed to directly access the data lake. In order to access the data lake, a user uses workflow gateways to get to the data needed. The workflow gateways require a user to initially connect to an AI retrieval system which vets the transaction request and validates that the role and need justifications are valid. The AI gateway will also ensure that the outgoing data reply will be secured, for example, using end-to-end encryption security. This ensures that the data can only be decrypted by the right party. As the privacy sensitive data is tokenized or encrypted, the AI system will need to detokenize or decrypt when necessary. The AI system may create more than one transaction, for example, more than a single data delivery to resolve other privacy and security protection issues. These complex measures are deftly executed using AI decision making processes.

The operational architecture of the system is based on distributed AI operations. The operational architecture of the system is fault tolerant and secure, despite executing on numerous diverse environments, including different cloud environments, such as on-premise or hybrid with public clouds. Additionally, the operational architecture employs a data lake strategy in the form of mass storage of data objects that are first AI processed for improved search via AI tagging, privacy and confidentiality protection using privacy enhancements such as tokenization and various encryption techniques such as Format Preserving Encryption (FPE), prior to saving into the Data Lake.

The core AI operational system integrates and defends edge AI devices in unique ways, such as using message paths secured by data diodes, data object inspection using AI gateways and using AI to generate secure transactions for external parties. The system effectively is “high wall” and self-defending as it supports secure logging that cannot be erased by attackers. Furthermore, the system tracks abnormalities and attack signatures via AI log examination and event correlation.

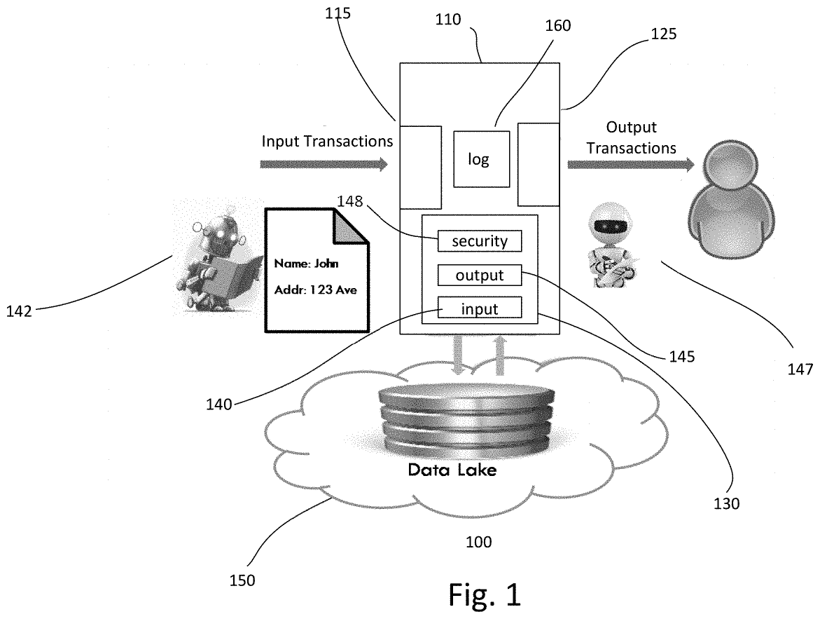

FIG. 1 shows an overview of an embodiment of a system architecture of a data storage and retrieval system 100. The storage system includes a gateway module 110 communicatively coupled to a data storage module 150. The data storage module, in one embodiment, is configured as a data lake. For example, a data lake provides data storage in its native format. This provides easy ingestion of data. As shown, the data lake is located in a cloud. Other configurations of data lakes may also be useful.

As for the gateway module, in one embodiment, it is an intelligent gateway module. For example, the gateway is an AI driven gateway module, serving as AI gateways for incoming or outgoing data. In one embodiment, the AI driven gateway module is based on distributed AI operations. The gateway module includes input and output platforms 115 and 125. The input platform receives input or instream data. Each segment or group of instream data may be referred to as an instream transaction. Instream transactions may include, for example, IoT remote sensing data, customer orders, customer queries or complaints, delivery orders, payments, forum information as well as other types or sources of data. The instream transactions may be, as discussed, in the native format of the recipient. As such, different instream transactions may include different native formats. The data lake facilities handling of high velocity and huge volumes of data. In one embodiment, the input platform is configured to receive instream transactions from numerous sources. The input platform, in one embodiment, may be configured to receive instream transactions from numerous sources and processed in parallel.

Instream transactions are processed by a processing module 130 of the AI gateway and subsequently stored in the data lake as data fragments. The processing module, in one embodiment, includes an input processing unit 140. The input processing unit is configured to process instream transactions. Processing includes categorizing the data of the instream transactions. For example, processing instream transactions include determining the data type of the instream transactions. If any data element of an instream transaction is determined to be a private or a sensitive data element, such as a PII data element, it is privacy protected. In one embodiment, privacy protection includes encrypting the data element. In one embodiment, encryption employs tokenization. The tokenization, in one embodiment, includes format preserving encryption (FPE). Other types of encryption techniques may also be useful.

FPE encrypts the data element such that the encrypted data element (ciphertext) is in the same format as the input data element (plaintext). The term format may vary from data element to data element. Examples include as follows:
a) a 16 digit credit card number is encrypted so that the ciphertext is another 16-digit number;
b) an English word is encrypted so that the ciphertext is another English word; and
c) an n-bit number (n-bit block) is encrypted so that the ciphertext is another n-bit number.

It is understood that the examples are non-exhaustive and non-limiting. For example, data elements may have other types of formats, including alphanumeric formats.

In one embodiment, an instream data transaction is processed by parsing it into data fragments or elements. The parsing, in one embodiment, may be performed using AI semantics parsing using natural language processing (NLP) to understand which part of the incoming data must be privacy protected. For example, structured and semi-structured data, such as xml records, are classified using AI classification to understand the nature of the data elements and fields to detect if they are PII or privacy-sensitive. In addition, entity extraction, such as address, and names of persons, is achieved using AI text processing. Those data elements which required privacy protected are encrypted. The parsed incoming data are stored as data fragments in the data lake.

In one embodiment, the input processing unit performs entity resolution on the instream transactions. For example, the input processing unit tracks the incoming transactions, including customer queries and complaints and forum information to group all such data events to identify the customer as unique, who may otherwise appear to be from different persons. Unique customers can be detected and resolved using unique address, phone numbers and partly matching names or alias or as matched due to a unique email address or cookie tracking. In addition, mobile web surfing could exploit user tracking, which can be authenticated via biometrics and phone hardware.

Data elements of instream transactions from unique users are tagged with a unique user ID. For example, all data elements from instream transactions from a user are tagged with the user's unique ID before being stored in the data lake. For example, additional data tagging is created for the data fragments prior to being stored in the data lake. Tagging unique user IDs to data fragments facilitates analytics and 360° view of customers since anonymization or tokenization can be used later to track total activities as belonging to the actual person and related persons, instead of different unrelated persons.

Tagging may also include tagging the data fragments with other types of tags, such as date of transaction, type of transaction, class of goods of the transaction, the channel used by the transaction as well as whether it is tokenized or not. Other types of tags may also be provided to the data fragments. For example, tagging whether the data fragment includes potential false data or that the data fragment is to be anonymized. Tagging the data fragments enables faster retrieval of data and higher security granularity when accessed later.

In one embodiment, the input processing unit performs other functions on instream data. The instream data, for example, is checked to see if there are malware present which can pose security risks. Malware, in one embodiment, are removed prior to storing in the data lake.

The various functions performed by the input processing unit may be facilitated by software bots 142. Each software bot may be programmed to perform specific functions on the instream data. The bots are configured to operate or process the instream data as a swarm. For example, the bots are configured as swarmbots to process the instream data. Furthermore, the processing unit is scalable, depending on the amount of instream data required. For example, swarmbots may be self-replicating to scale up or deleted for scaling down.

The output platform of the AI gateway processes requests for data from the data lake and generates output transactions. The processing module includes an output processing unit 145 for processing requests for data from the data lake. To ensure security protocols, data requests need to be from workflow gateways which are secured. For example, requests through the workflow gateways of the AI gateway module which connect to the system include vetting the transaction requests and validating the requests. The workflow gateways ensure that the outgoing data replies are secured. For example, the workflow gateways ensure that outgoing data replies are secured using end-to-end encryption security. In other words, an outgoing data reply can only be decrypted by the right party.

Hacking attacks will be countered via cyber security and refined access control. For example, requests or accesses to the system are logged in an access or event log 160. A security unit 148 of the processing module continuously monitors the log to protect the system from unwanted attacks and breaches. For example, an unwanted access triggers a security breach.

As described, the system integrates and defends edge devices, for example, by using message paths secured by data diodes, data object inspection using AI gateways and using AI to generate secure transactions for external parties. The system, in essence, is “high wall” and self-defending, supporting secure logging that cannot be erased by attackers. The system tracks abnormalities and attacks signatures via AI log examination and event correlation. The system regulates the roles and functional privacy validity of requests coming from secure workflow gateways, supporting compliance to privacy regulations, such as GPDR. In addition, privacy leakage is prevented and theft management is enhanced by encryption, such as by tokenization as well as PII masking of data in transit and in storage.

Valid requests are processed by the output processing unit 145. The requests retrieve requested data from the data lake. Encrypted data fragments requested are decrypted. For example, tokenized data fragments are detokenized. In addition, the request may be parsed to identify information of the request. The system may create more than one output transaction (e.g., more than a single data delivery) to resolve other privacy and security protection issues.

The various functions performed by the output processing and security units may be facilitated by software bots 147. Each software bot may be programmed to perform specific functions on the requests and generate output transactions to the requester. The bots are configured to operate or process the requests as a swarm. For example, the bots are configured as swarmbots to process the requests. Furthermore, the output processing and security unit are scalable, depending on the volume of requests required. For example, swarmbots may be self-replicating to scale up or deleted for scaling down.

As described, the data objects or fragments of disparate transactions and events are consolidated by users. For example, customer data is efficiently consolidated as well as enabling efficient consolidation of various touch points. This avoids customers from having to perform multiple data entries. In addition, the system provides omnichannel support and employs highly efficient AI natural language search, for example, using deep learning attention. This provides a 360° view of the customers. Analytics can be deployed to answer questions using semantics NLP, enabling a better understanding of trends and motivations. This enables improved predictability of customer requirements, including optimizing delivery and timing of needs as well as suggesting better packaging, options and sharing offers that can cater to the needs of customers and their families as well.

Furthermore, the system is legacy friendly. For example, the system allows existing disparate and diverse data processing legacy workflow systems to be easily integrated with security and privacy functions. The present system streamlines the injection of new innovations, maintenance and the cost of operations through the use of public clouds. In addition, the system is designed to integrate and deliver coherently secure reporting, dashboards, signed transaction outputs and privacy-enhanced workflows. This is essentially a trusted environment that an end-user can self-service, see his own transactions and the AI will assist to offer him the best “buy” package.

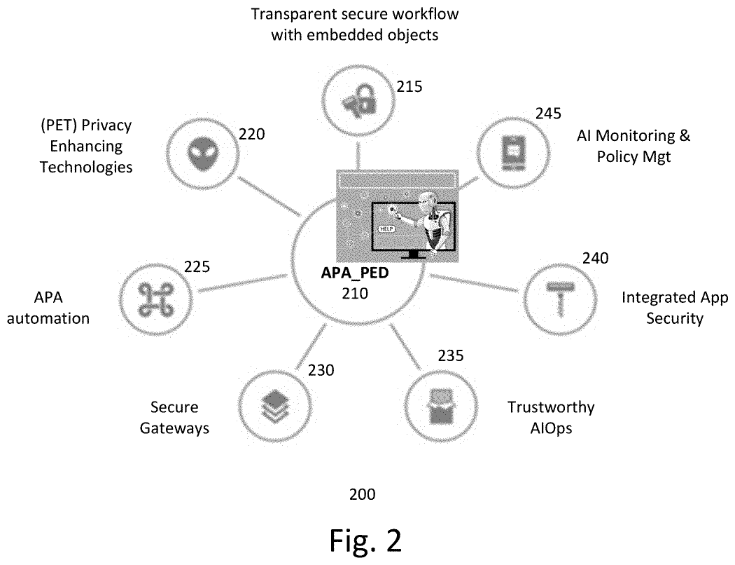

FIG. 2 shows an embodiment of a component architecture of the data storage and retrieval system 200. The system include an APA PED module 210. The PED module includes various units for processing instream transactions and generate ouput transactions based on valid data requests. In one embodiment, the PED module includes a transparent secure workflow with embedded objects unit 215, a privacy enhancing technologies unit 220, an APA automation unit 225, a secure gateways unit 230, a trustworthy AIOPs unit 235, an integrated APP security unit 240 and an AI monitoring and policy management unit 245. Providing the system with other units may also be useful.

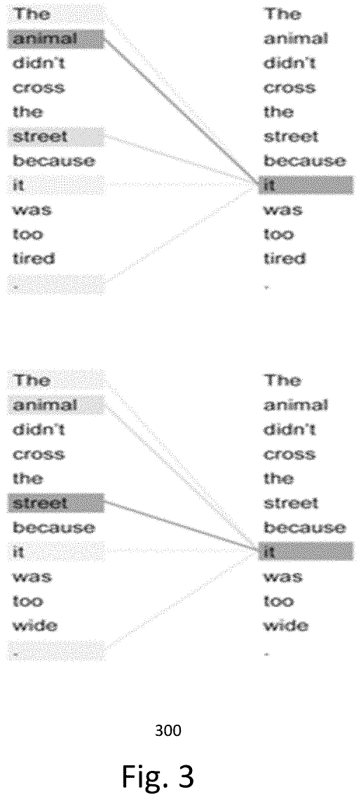

FIG. 3 illustrates an embodiment of an AI text attention model 300. Structured and semi-structured data, such as .xml records, are parsed using AI classification to understand the nature of the data elements and fields to detect if a data element is PII or privacy-sensitive. As shown, a sentence is parsed into data fragments or objects. Easy to parse text, for example, Singapore's National ID number (NRIC), may be parsed using regular expressions. Entity extraction, such as address, names of persons, may be achieved using AI text processing. Using AI semantics with attention parsing via NLP, privacy sensitive text may be detected. Privacy required data fragments are encrypted by, for example, a PII bot.

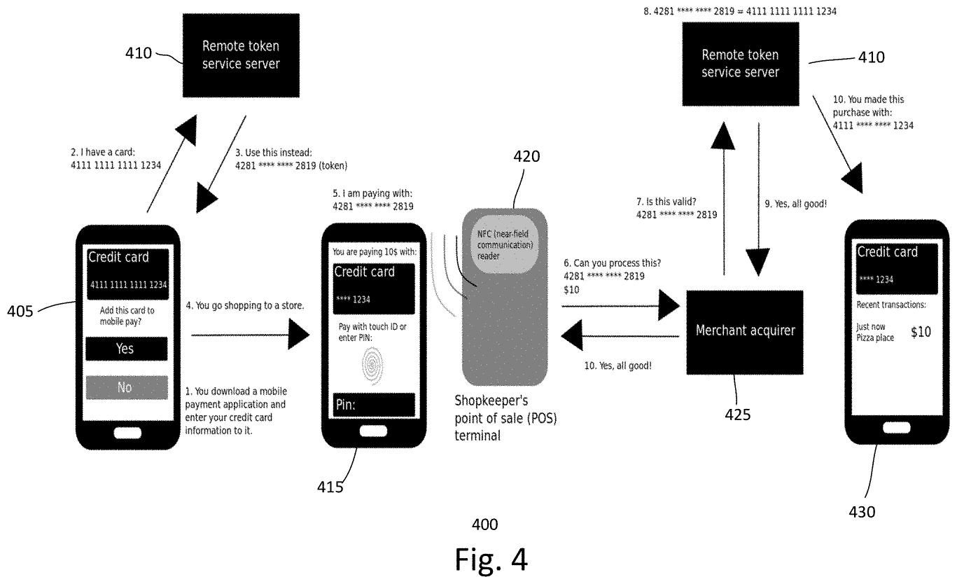

FIG. 4 shows an example of a tokenization process 400. In the example, a customer may download a mobile payment application (App) onto a mobile smartphone at 405. Once the App is installed, the customer may add a credit card to be used for payment purposes using the App. The customer may click “yes” to confirm the credit card. This causes the credit card number and other information to be submitted to a remote system 410 as, for example, an instream transaction. The remote system, for example, may be a remote token service server. The system processes the instream transaction. Processing includes parsing the instream transaction, identifying privacy sensitive data elements, and tokenizing the privacy sensitive data element using, for example, FPE. For example, the credit card number is tokenized

Tokenizing is the process of substituting a sensitive data element with a non-sensitive equivalent, which is referred to as a token. The token, by itself, has no extrinsic or exploitable meaning or value. The token is a reference, such as an identifier, that maps back to the sensitive data through a tokenization system. The mapping from original data to a token uses techniques which render tokens infeasible to reverse in the absence of the tokenization system. In the case of tokenizing a credit card number, the token is created from random numbers. The parsed data elements, including the tokenized data element, are tagged and stored in the data lake of the system. In addition, the tokenized data element is sent back to the customer's mobile phone for use in transactions.

The customer may desire to make a payment for a purchase using the mobile App at 415. The mobile App may inform the user that payment is with the selected credit card. The shop's point of sale terminal 420 processes payment using the selected credit card of the mobile App. The point of sale's terminal submits the transaction to a merchant acquirer system 425 to approve the transaction. Since the credit card information is tokenized, the merchant acquirer system forwards the information to the remote system 410, such as the remote token service server, for validation. For example, the merchant acquirer system submits the request through a secured workflow gateway.

The remote token service server processes the request. For example, the credit card number, which is the token, is detokenized to determine whether the number is valid or not. Once validated, the remote token service server informs the merchant acquirer which informs the shop that the transaction is approved. The remote server also informs the customer's App that the transaction was approved at 430.

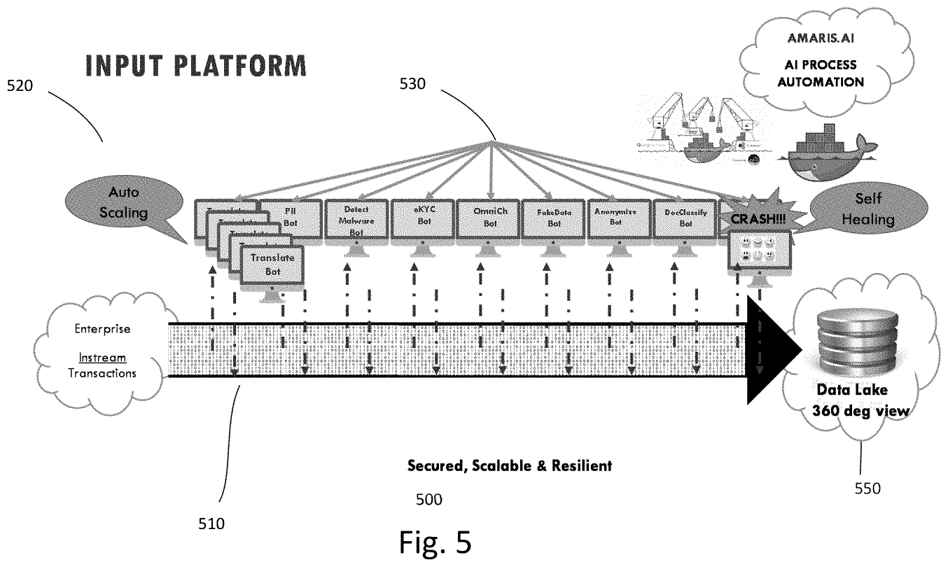

FIG. 5 shows an overview of an embodiment for processing instream transactions 500. Instream data transactions, for example, are received by the input platform 510 of AI driven gateway module. Instream transactions may include, for example, IoT remote sensing data, customer orders, customer queries or complaints, delivery orders, payments, forum information as well as other types or sources of data. The input platform may be configured to receive instream transactions from numerous sources and processed in parallel.

Instream transactions are processed by an input processing unit 520 of the processing module of the AI gateway. Processing includes categorizing the data of the instream transactions. For example, processing instream transactions include determining the data type of the instream transactions. If any data element of an instream transaction is determined to be a private or a sensitive data element, such as a PII data element, it is privacy protected. In one embodiment, privacy protection includes encrypting the data element. In one embodiment, encryption employs tokenization. The tokenization, in one embodiment, includes format preserving encryption (FPE). Other types of encryption techniques may also be useful.

In one embodiment, processing of instream transactions is facilitated by software bots. The bots are configured to operate or process the instream data as a swarm. For example, the bots are configured as swarmbots 530 to process the instream data.

As shown, the input processing unit includes translate bots, a PII bot, a detect malware bot, eKYC (know your customer) bot, omnichannel bot, a fake data bot, an anonymize bot and document classification bot, and a crash bot. The translate bots, for example, are employed to parse incoming transactions. The translate bots employ, for example, AI semantics parsing using natural language processing (NLP). The translate bots, in one embodiment, are autoscaling. For example, the translate bots are configured to be self-replicating based on the volume of instream transactions.

The PII bot identifies privacy sensitive data elements of the instream transactions and encrypts them, for example, using tokenization with FPE. The malware bot examines the instream transactions for the presence of malware and removes it. The eKYC bot performs entity resolution from the parsed instream transactions. The omnichannel bot identifies the channel from which an instream transaction originates. The fake data bot identifies fake data from the instream transactions. The document classification bot classifies the instream transactions. As for the anonymize bot, it may be employed to anonymize users of the instream transactions. The crash bot serves to restore the instream transactions in the event of a system crash. As such, the system is self-healing. The processed instream transactions are stored in the data lake 550 as data objects or fragments with tagging.

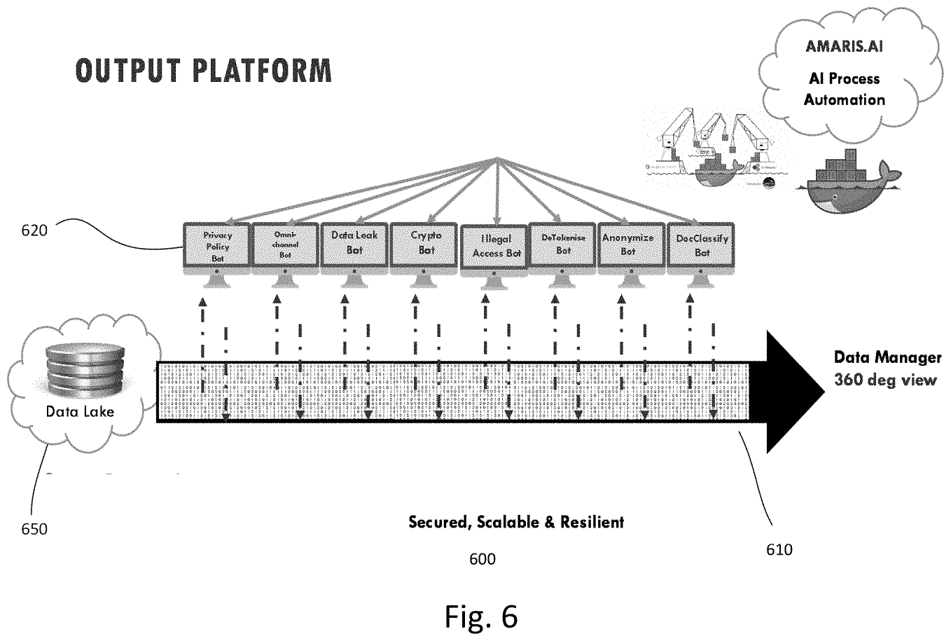

FIG. 6 shows an overview of an embodiment 600 for processing requests to generate output transactions. An output platform 610 of the AI gateway processes requests for data from the data lake 650 and generates output transactions. The processing module includes an output processing unit 620 for processing requests for data from the data lake. To ensure security protocols, data requests need to be from workflow gateways which are secured. For example, requests through the workflow gateways of the AI gateway module which connect to the system include vetting the transaction requests and validating the requests. The workflow gateways ensure that the outgoing data replies are secured. For example, the workflow gateways ensure that outgoing data replies are secured using end-to-end encryption security.

Processing of requests may be performed by, for example, software bots of the output processing unit. The bots are configured to operate or process the requests as a swarm. For example, the bots are configured as swarmbots 630 to process the requests.

As shown, the output processing unit includes a private policy bot, an omnichannel bot, a data leak bot, a cryto bot, an illegal access bot, a detokenize bot, an anonymize bot, and a document classification bot. The private policy bot determines if the request complies with the policies. The omnichannel bot determines from which channel the requests originated. The data leak bot determines if there are data leaks from the data requests. The illegal access bot determines if the request is from a workflow gateway. If it is not from a workflow gateway, the request is an illegal access. The detokenize bot identifies requested data fragments which require detokenizing. The anonymize bot anonymize the customer information of the data requests. The documents classification classifies the type of requests. Valid requests are processed to generate output transactions.

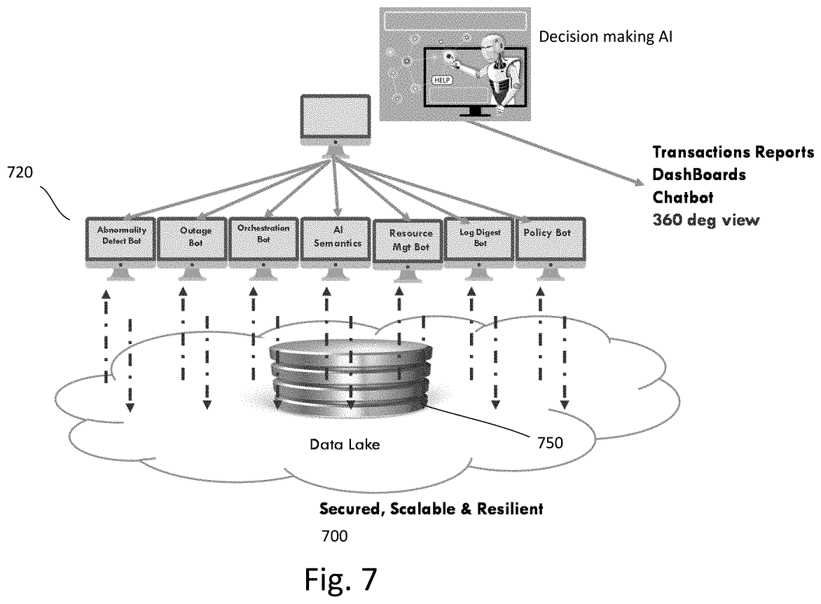

FIG. 7 shows an overview of an embodiment for continuous monitoring of the system 700, for example, to maintain AIOps health and security of the system. A security unit 720 of the processing module performs continuous monitoring of the system. As shown, the security unit includes software bots for continuously monitoring the system. The bots are configured to continuously monitor the system. For example, the bots are configured as swarmbots to continuously monitor the system.

As shown, the security unit includes an abnormality detection bot, an outage detection bot, an orchestration bot, an AI semantic bot, a resource management bot, a log digest bot and a policy bot. The log digest bot logs requests and accesses to the system. The abnormality detection bot examines the log to identify any abnormalities. The outage bot determines if there are any outages occurring in the system. The policy bot ensures that policies are complied with. The resource management bot manages resources of the system. In addition, a chatbot may be provided. The chatbot enables creation of transaction reports and dashboards based on data analytics performed on the data objects in the data lake with 360° view of customers.

The inventive concept of the present disclosure may be embodied in other specific forms without departing from the spirit or essential characteristics thereof. The foregoing embodiments, therefore, are to be considered in all respects illustrative rather than limiting the invention described herein. Scope of the invention is thus indicated by the appended claims, rather than by the foregoing description, and all changes that come within the meaning and range of equivalency of the claims are intended to be embraced therein.

What is claimed is:

1. A data storage and retrieval system comprising:
a data storage module, the data storage module comprises a data lake for storing unstructured data fragments;
a gateway module, the gateway module is configured to process instream transactions, wherein processing of an instream transaction comprises
identifying any privacy data elements in the instream transaction,
encrypting the privacy data element or elements, and
storing the instream transaction as data fragments in the data storage module; and
wherein processing the instream transactions renders the data storage module compliant with privacy data regulations.

2. The system of claim 1 wherein the gateway module comprises an input processing unit configured to process the instream transactions, the input processing unit includes AI-empowered process automation for processing the instream transactions.

3. The system of claim 2 wherein processing of the instream transactions by the input processing unit comprises:
parsing an incoming instream transaction using natural language processing (NLP) into data objects;
identifying data objects which are privacy data elements;
encrypting the data objects which are privacy data elements; and
tagging the data objects; and
storing the data objects in the data lake.

4. The system of claim 3 wherein the input processing unit comprises software bots for processing the instream transactions.

5. The system of claim 4 wherein the software bots are configured to operate in a swarm to process the instream transactions

6. The system of claim 4 wherein the software bots are scalable based on volume of the instream transactions.

7. The system of claim 3 wherein the data objects stored in the data lake provides a 360° view of customers.

8. The system of claim 1 wherein the gateway module comprises an output processing unit configured to process access requests to the data storage module to generate output transactions to access requestors.

9. The system of claim 8 wherein the access requests by the access requestors are received through workflow gateways coupled to the gateway module, wherein the workflow gateways are secured gateways to ensure access requests are valid access requests from authorized access requestors.

10. The system of claim 9 wherein the valid access requests are processed by the output processing unit, wherein encrypted privacy data elements of the valid access requests are decrypted prior to sending back to the authorized access requestors.

11. The system of claim 10 wherein the output processing unit comprises software bots for processing the access requests.

12. The system of claim 11 wherein the software bots are configured to operate in a swarm to process the access requests.

13. The system of claim 1 wherein the gateway module comprises a security unit configured to continuously monitor the system to maintain operation health and security.

14. The system of claim 13 wherein the security unit comprises software bots for continuously monitoring the system.

15. A method for storing data:
receiving instream transactions from different data sources;
processing the instream transactions, wherein processing the instream transactions comprises identifying any data element of a transaction which is privacy sensitive and encrypting the identified privacy sensitive data elements; and
storing the instream transactions into a data lake as unstructured data fragments, including the privacy sensitive data elements, wherein the data lake contains unstructured data fragments which comply with privacy data regulations and provide a 360° view of customers.

16. The method of claim 15 wherein processing of the instream transactions are facilitated by an input processing unit, wherein the input processing unit comprises software bots configured to operate in a swarm for processing the instream transactions.

17. The method of claim 15 further comprises receiving access requests through workflow gateways which are configured to ensure the access requests are valid access requests from authorized access requestors.

18. The method of claim 17 further comprises processing the valid access requests, wherein the processing includes decrypting encrypted privacy sensitive data elements of the valid access requests before generating output transactions to the authorized access requestors.

19. The method of claim 18 wherein processing of the valid access requests is facilitated by software bots configured to operate in a swarm to process the access requests.

20. The method of claim 19 further comprises continuous monitoring of the instream and output transactions via a security unit, wherein the security unit comprises software bots configured for facilitating the continuous monitoring.
